(19) United States
(12) Patent Application Publication
(10) Pub. No.: US 2012/0079405 A1
(43) Pub. Date: Mar. 29, 2012

(54) WIDGET DISPLAYING SYSTEM AND METHOD

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/155,711

(22) Filed: Jun. 8, 2011

(30) Foreign Application Priority Data
Sep. 29, 2010 (TW) 99133054

(51) Int. Cl. G06F 3/048

(52) U.S. Cl. 715/769

(57) ABSTRACT

A widget displaying system of an electronic device includes a widget listing module, a widget moving module and a widget display module. The widget listing module generates a list of widgets that are registered to the electronic device, and displays the list on a home screen of the electronic device. The widget moving module drags and drops a widget from the list to an idle area of the home screen. The widget display module displays the widget in the idle area.

### BACKGROUND

1. Technical Field

The disclosure generally relates to a widget displaying system and a method.

2. Description of Related Art

A widget is an element of a graphical user interface (GUI) that displays information changeable by the user, such as a window or a text box. The defining characteristic of a widget is to provide a single interaction point for direct manipulation of a given kind of data. In other words, widgets are basic visual building blocks, which combined in an application hold all the data processed by the application and the available interactions on this data. However, if a user wants to add a widget on a home screen or a desktop, there needs to be a way to easily do this.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a widget displaying system installed in an electronic device.

FIG. 2 is a schematic view of an UI of a widget displaying system in an embodiment.

FIG. 3 is a flowchart illustrating one embodiment of a widget displaying method using the widget displaying system of FIG. 1.

FIG. 4 is a flowchart of a method for dragging and dropping the widget to an idle area of a home screen of FIG. 3.

FIG. 5 is a flowchart of a method for displaying the widget in the idle area of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. Modules may comprise connected logic units, such as gates and flip-flops, and programmable units such as programmable gate arrays or processors. The modules described herein may be implemented as software and/or hardware modules and may be stored in any type of computer-readable medium or other computer storage device.

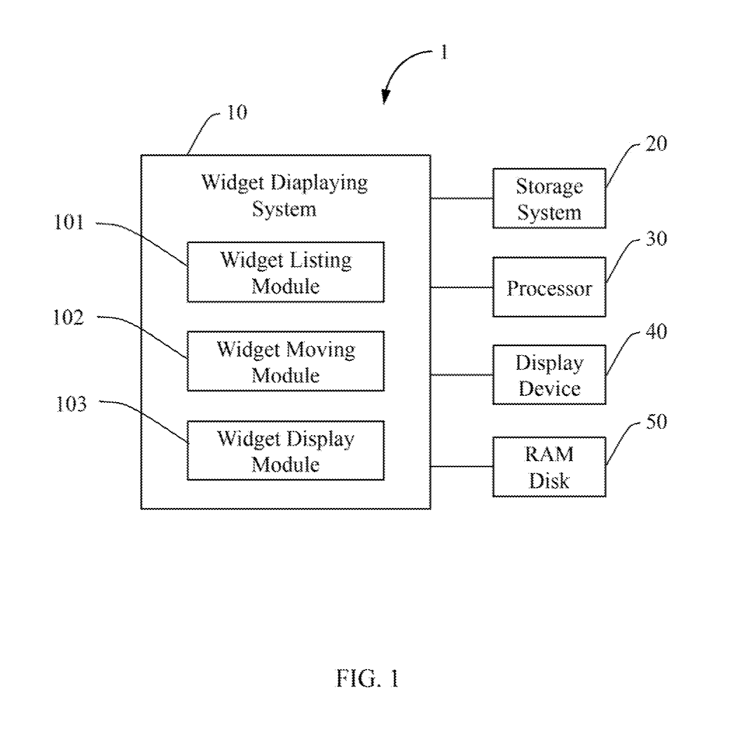

FIG. 1 is a schematic diagram of one embodiment of an electronic device 1. In the embodiment, the electronic device 1 may include a widget displaying system 10, a storage system 20, at least one processor 30, and a display device 40. In some embodiments, the electronic device 1 may further include a RAM disk 50. The RAM disk 50 is a block of RAM that software in a computer treats as if the memory were a disk drive. The widget displaying system 10 may display widgets on a home screen of the display device 40 of the electronic device 1. One or more computerized codes of the widget displaying system 10 are stored in the storage system 20 and executed by the at least one processor 30.

In one embodiment, the storage system 20 may be a magnetic or an optical storage system, such as a hard disk drive, an optical drive, or a tape drive. The storage system 20 also stores corresponding data of widgets that are registered to the electronic device 1. The display device 40 is configured with a display screen, such as a liquid crystal display (LCD) or a cathode-ray tube (CRT) display.

In one embodiment, the widget displaying system 10 includes a widget listing module 101, a widget moving module 102, and a widget display module 103. Each of the modules 101-103 may be a software program including one or more computerized instructions that are stored in the storage system 20 and executed by the processor 30.

The widget listing module 101 generates a list of widgets that are registered to the electronic device 1, and displays the list on a home screen of the display device 40. In general, a widget associated with an application needs to provide some essential data to a host system (for example, an OS) in the register process. The essential data may include size, preview icon, and associated application information of the widget.

The widget moving module 102 drags and drops a widget from the list to an idle area of the home screen. The widget moving module 102 selects a widget from the list by detecting a click operation on a widget in the list, and then associates the widget with an identification number. The identification number is used to identify a unique widget. The widget moving module 102 detects the dragging and dropping operations performed by a user. The widget moving module 102 moves a profile of the widget on the home screen according to the dragging operation. A profile of the widget may be a preview icon of the widget, a block that is equal to the size of the widget or a snapshot of the widget. The widget moving module 102 determines whether the location where the dropping operation is performed is an idle area.

If the location is an idle area, the widget moving module 102 records the location and the identification number of the widget in a widget library, generates a broadcast of request for displaying the widget in the idle area with a predefined tag, and broadcasts the broadcast in the electronic device 1. The predefined tag is used to discriminate the broadcast generated by the widget moving module 102 from the others, like ones generated by the host system of the electronic device 1. The widget moving module 102 acquires the size of the widget, and determines whether the size of area of the location is smaller than the size of the widget. If the size of area of the location is larger than or equal to the size of the widget, the widget moving module 102 records the size of the widget in the widget library.

The widget display module 103 is used to display the widget in the idle area. The widget display module 103 may receive a broadcast, and determine whether the received broadcast has the predefined tag.

If the received broadcast has the predefined tag, the widget display module 103 extracts an identification number from the received broadcast.

If the received broadcast does not have the predefined tag, the widget display module 103 determines whether the received broadcast is the first received broadcast among the duration from startup of the electronic device to present when the received broadcast does not have the predefined tag. If the received broadcast is the first received broadcast, the widget display module 103 acquires an identification number from the widget library. In one embodiment, the widget display module 103 determines whether there is a predefined file in the RAM disk 50 of the electronic device 1. If there is a predefined file in the RAM disk 50, the received broadcast is determined as the first received broadcast. If there is no such a predefined file in the RAM disk 50, the widget display module 103 creates the predefined file in the RAM disk 50.

The widget display module 103 may determine a widget by the identification number and then display the widget in the idle area.

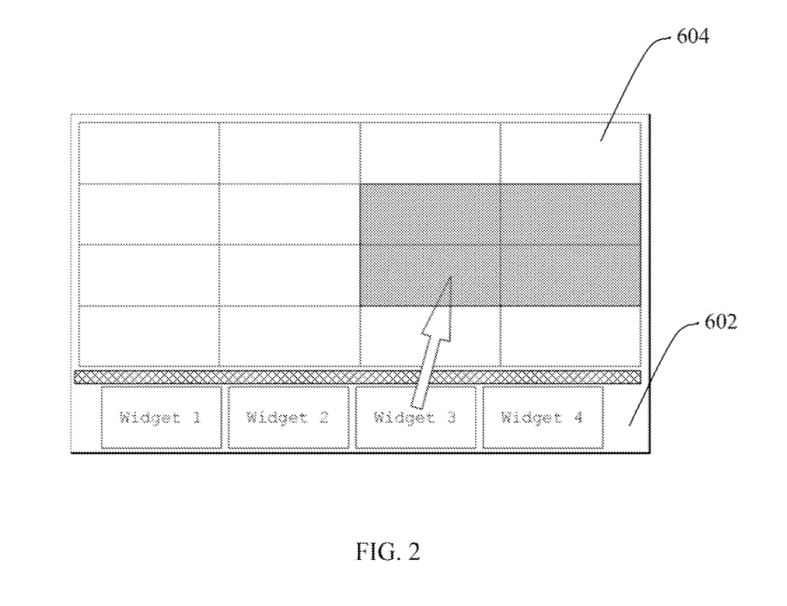

FIG. 2 is a schematic view of an UI of a widget displaying system in an embodiment. A home screen of the display device 40 includes an area 602 for displaying a widget list, and an area 604 for displaying widgets. The widget listing module 101 displays a widget list on the area 602. If one of the widgets (i.e., widget 3) is selected, dragged and dropped to the area 604 by the widget moving module 102. The widget 3 has a size of 2×2 cells on the home screen. When the widget 3 is dragged on the home screen, the widget moving module 102 shows a profile of the widget 3 in the location where the dragging operation is performed. The profile of the widget 3 may be a preview icon of the widget 3, a block of 2×2 cells that is equal to the size of the widget 3 or a snapshot of the widget 3.

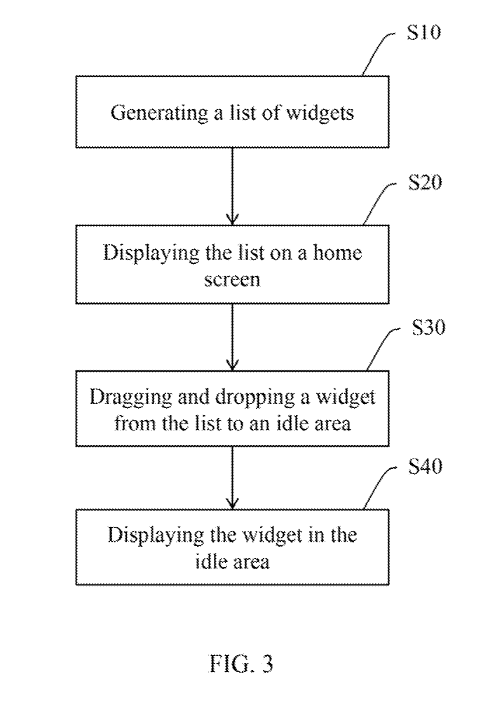

FIG. 3 is a flowchart illustrating one embodiment of a widget displaying method using the widget displaying system of FIG. 1. The method may include the following blocks.

In block S10, the widget listing module 101 generates a list of widgets that are registered to the electronic device 1.

In block S20, the widget listing module 101 displays the list on a home screen of the display device 40.

In block S30, the widget moving module 102 drags and drops a widget from the list to an idle area of the home screen.

In block S40, the widget display module 103 displays the widget in the idle area.

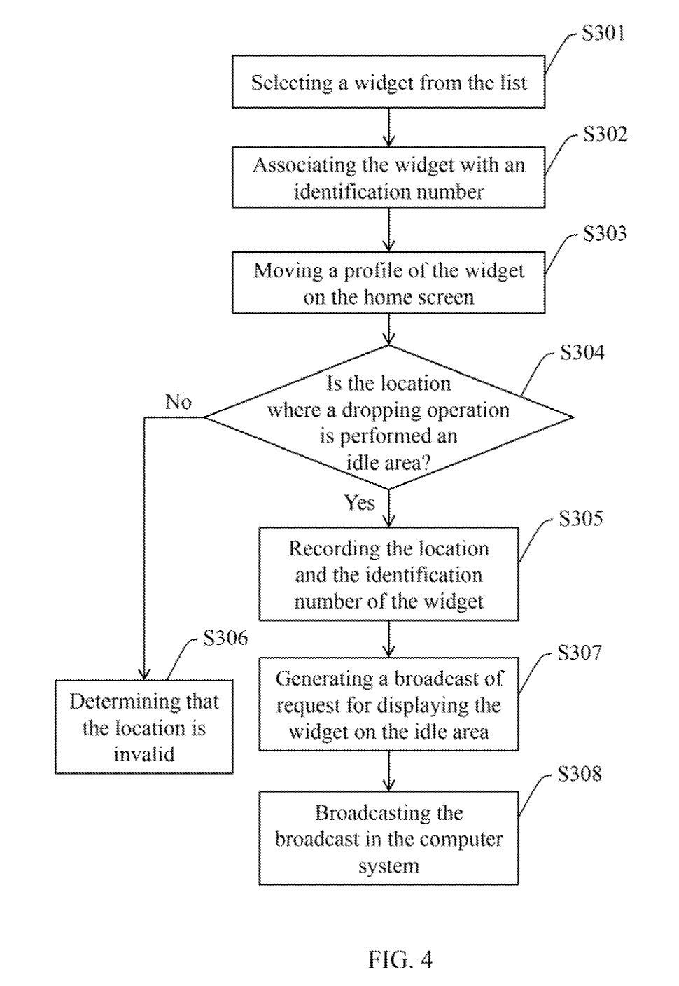

Referring to FIG. 4, a method for dragging and dropping the widget to an idle area of a home screen of FIG. 3 may include the following blocks.

In block S301, the widget moving module 102 selects a widget from the list by detecting a click operation on a widget in the list.

In block S302, the widget moving module 102 associates the widget with an identification number.

In block S303, the widget moving module 102 detects dragging and dropping operations performed by a user. The widget moving module 102 moves a profile of the widget on the home screen according to the dragging operation.

In block S304, the widget moving module 102 determines whether the location where the dropping operation is performed is an idle area. If the location is an idle area, the flow goes to block S305. If the location is not an idle area, the flow goes to block S306.

In block S305, the widget moving module 102 records the location and the identification number of the widget in a widget library, and the flow goes to block S307.

In block S306, the widget moving module 102 determines that the location is invalid.

In block S307, the widget moving module 102 generates a broadcast request for displaying the widget in the idle area with a predefined tag.

In block S308, the widget moving module 102 broadcasts the broadcast request in the electronic device 1.

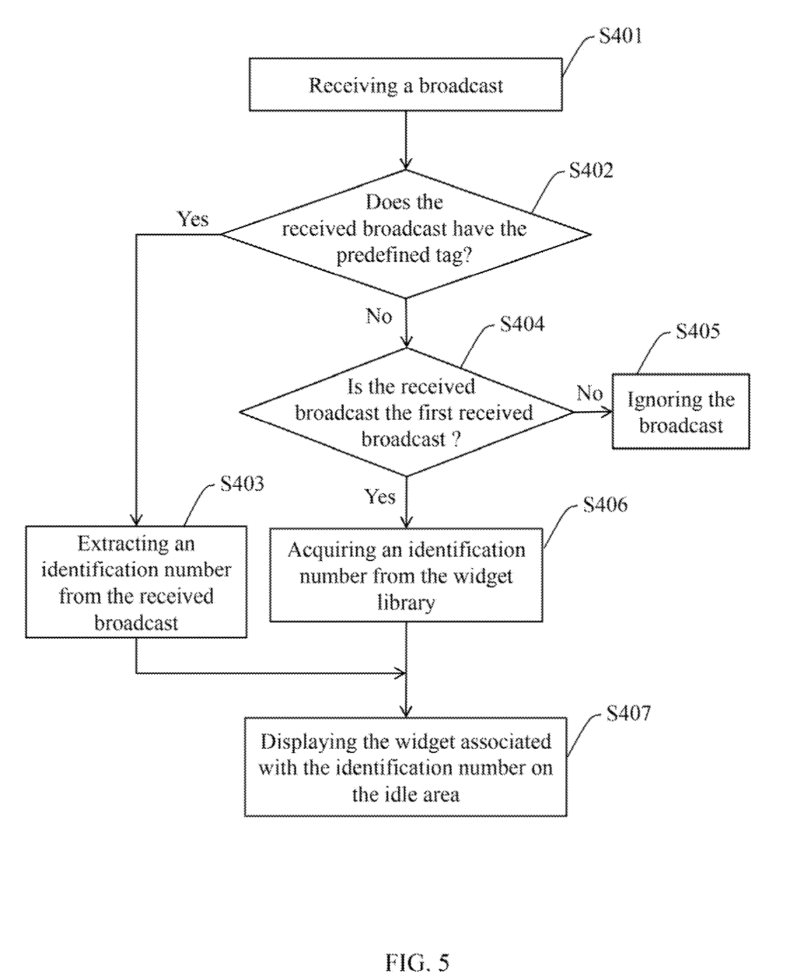

Referring to FIG. 5, a method for displaying the widget in the idle area of FIG. 3 may include the following blocks.

In block S401, the widget display module 103 receives a broadcast.

In block S402, the widget display module 103 determines whether the received broadcast has the predefined tag. If the received broadcast has the predefined tag, the flow goes to block S403. If the received broadcast does not have the predefined tag, the flow goes to block S404.

In block S403, the widget display module 103 extracts an identification number from the received broadcast, and the flow goes to block S407.

In block S404, the widget display module 103 determines whether the received broadcast is the first received broadcast among the duration from startup of the electronic device to present. If the received broadcast is the first received broadcast, the flow goes to block S406. If the received broadcast is not the first received broadcast, the flow goes to block S405.

In block S405, the widget display module 103 ignores the received broadcast.

In block S406, the widget display module 103 acquires an identification number from the widget library, and the flow goes to block S407.

In block S407, the widget display module 103 displays the widget associated with the identification number in the idle area.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method of displaying a widget on an electronic device, comprising:
generating a list of widgets that are registered to the electronic device;
displaying the list on a home screen of the electronic device;
dragging and dropping a widget from the list to an idle area of the home screen; and
displaying the widget in the idle area.

2. The method of the claim 1, wherein the block of dragging and dropping a widget from the list to an idle area of the home screen further comprises:
selecting a widget from the list by detecting a click operation on a widget in the list;
associating the widget with an identification number;
moving a profile of the widget on the home screen according to a dragging operation;
determining whether the location where a dropping operation is performed is an idle area; and
recording the location and the identification number of the widget in a widget library when the location is an idle area.

3. The method of the claim 2, wherein the block of dragging and dropping a widget from the list to an idle area of the home screen further comprises:
generating a broadcast of request for displaying the widget in the idle area with a predefined tag; and
broadcasting the broadcast in the electronic device.

4. The method of the claim 2, wherein the block of determining whether the location where a dropping operation is performed is an idle area further comprises:
acquiring the size of the widget; and
determining whether the size of area of the location is smaller than the size of the widget.

5. The method of the claim 4, wherein the block of dragging and dropping a widget from the list to an idle area of the home screen further comprises:
recording the size of the widget in the widget library when the location is an idle area.

6. The method of the claim 3, wherein the block of displaying the widget in the idle area further comprises:
receiving a broadcast;
determining whether the received broadcast has the predefined tag;
extracting an identification number from the received broadcast when the received broadcast has the predefined tag;
further determining whether the received broadcast is the first received broadcast among the duration from startup of the electronic device to present when the received broadcast does not have the predefined tag;
acquiring an identification number from the widget library when the received broadcast is the first received broadcast among the duration from startup of the electronic device to present; and
displaying the widget associated with the identification number in the idle area.

7. The method of the claim 6, wherein the block of determining whether the received broadcast is the first received broadcast among the duration from startup of the electronic device to present further comprises:
determining whether there is a predefined file in a RAM disk of the electronic device; and
creating a predefined file when there is no predefined file in the RAM disk.

8. A widget displaying system of an electronic device, comprising:
a widget listing module adapted to generate a list of widgets that are registered to the electronic device, and display the list on a home screen of the electronic device;
a widget moving module adapted to drag and drop a widget from the list to an idle area of the home screen; and
a widget display module adapted to display the widget in the idle area.

9. The system of the claim 8, wherein the widget moving module is further adapted to select a widget from the list by detecting a click operation on a widget in the list, associate the widget with an identification number, move a profile of the widget on the home screen according to a dragging operation, determine whether the location where a dropping operation is performed is an idle area, and record the location and the identification number of the widget in a widget library when the location is an idle area.

10. The system of the claim 9, wherein the widget moving module is further adapted to generate a broadcast of request for displaying the widget in the idle area with a predefined tag, and broadcast the broadcast in the electronic device.

11. The system of the claim 9, wherein the widget moving module is further adapted to acquire the size of the widget, and determine whether the size of area of the location is smaller than the size of the widget.

12. The system of the claim 11, wherein the widget moving module is further adapted to record the size of the widget in the widget library when the location is an idle area.

13. The system of the claim 10, wherein the widget display module is further adapted to receive a broadcast, determine whether the received broadcast has the predefined tag, extract an identification number from the received broadcast when the received broadcast has the predefined tag, further determine whether the received broadcast is the first received broadcast among the duration from startup of the electronic device to present when the received broadcast does not have the predefined tag, acquire an identification number from the widget library when the received broadcast is the first received broadcast among the duration from startup of the electronic device to present, and display the widget associated with the identification number in the idle area.

14. The system of the claim 13, wherein the widget display module is further adapted to determine whether there is a predefined file in a RAM disk of the electronic device, and create a predefined file when there is no predefined file in the RAM disk.

15. A non-transitory storage medium having stored thereon instructions that, when executed by a processor of an electronic device, cause the electronic device to perform a widget displaying method, the method comprising:
generating a list of widgets that are registered to the electronic device;
displaying the list on a home screen of the electronic device;
dragging and dropping a widget from the list to an idle area of the home screen; and
displaying the widget in the idle area.

16. The storage medium of the claim 15, wherein the block of dragging and dropping a widget from the list to an idle area of the home screen comprises:
selecting a widget from the list by detecting a click operation on a widget in the list;
associating the widget with an identification number;
moving a profile of the widget on the home screen according to a dragging operation;
determining whether the location where a dropping operation is performed is an idle area; and
recording the location and the identification number of the widget in a widget library when the location is an idle area.

17. The storage medium of the claim 16, wherein the block of dragging and dropping a widget from the list to an idle area of the home screen further comprises:
generating a broadcast of request for displaying the widget in the idle area with a predefined tag; and
broadcasting the broadcast in the electronic device.

18. The storage medium of the claim 16, wherein the block of determining whether the location where a dropping operation is performed is an idle area further comprises:
acquiring the size of the widget; and
determining whether the size of area of the location is smaller than the size of the widget.

19. The storage medium of the claim 17, wherein the block of displaying the widget in the idle area comprises:
receiving a broadcast;
determining whether the received broadcast has the predefined tag;
extracting an identification number from the received broadcast when the received broadcast has the predefined tag;
further determining whether the received broadcast is the first received broadcast among the duration from startup of the electronic device to present when the received broadcast does not have the predefined tag;
acquiring an identification number from the widget library when the received broadcast is the first received broadcast among the duration from startup of the electronic device to present; and
displaying the widget associated with the identification number in the idle area.

20. The storage medium of the claim 19, wherein the block of determining whether the received broadcast is the first received broadcast among the duration from startup of the electronic device to present comprises:
determining whether there is a predefined file in a RAM disk of the electronic device; and
creating a predefined file when there is no predefined file in the RAM disk.
